(19) United States
(12) Patent Application Publication
(10) Pub. No.: US 2026/0118251 A1
(43) Pub. Date: Apr. 30, 2026

(54) NANOPARTICLE DETECTION WITH INTEGRATED NANOPARTICLE COMPOSITION DETERMINATION

(71) Applicant: Elemental Scientific, Inc., Omaha, NE (US)

(72) Inventors: Myung Hwan Kim, Omaha, NE (US); Daniel R Wiederin, Omaha, NE (US); Austin Schultz, Omaha, NE (US); Jonathan Hein, Omaha, NE (US)

(21) Appl. No.: 19/370,988

(22) Filed: Oct. 28, 2025

Related U.S. Application Data
(60) Provisional application No. 63/713,659, filed on Oct. 30, 2024.

(51) Int. Cl. G01N 15/1434; G01N 15/14; H01J 49/10

(52) U.S. Cl. CPC G01N 15/1434; H01J 49/105; G01N 2015/1486

(57) ABSTRACT

Systems and methods for analyzing fluid samples containing nanoparticles for the determination of nanoparticle count and nanoparticle elemental composition are described. In an aspect, a system embodiment includes, but is not limited to, a remote sampling system configured to receive a fluid sample containing nanoparticles, the remote sampling system including a particle counter configured to determine a number of nanoparticles present in the fluid sample via light scattering detection; a sample analysis system configured to receive the fluid sample from the remote sampling system, the sample analysis system including a mass spectrometer configured to determine an elemental composition of the nanoparticles present in the fluid sample; and a system controller communicatively configured to provide a distribution of the nanoparticles in the fluid sample by specific element type based on an output from each of the mass spectrometer and the particle counter.

### CROSS-REFERENCE TO RELATED APPLICATIONS

The present application claims the benefit of 35 U.S.C. § 119(e) of U.S. Provisional Application Ser. No. 63/713,659, filed Oct. 30, 2024, and titled “NANOPARTICLE DETECTION WITH INTEGRATED NANOPARTICLE COMPOSITION DETERMINATION.” U.S. Provisional Application Ser. No. 63/713,659 is herein incorporated by reference in its entirety.

### BACKGROUND

Inductively coupled plasma (ICP) mass spectroscopy is an analysis technique commonly used for the determination of trace element concentrations and isotope ratios in liquid samples. ICP mass spectroscopy employs electromagnetically generated partially ionized argon plasma which reaches a temperature of approximately 7000K. When a sample is introduced to the plasma, the high temperature causes sample atoms to become ionized or emit light. Since each chemical element produces a characteristic mass or emission spectrum, measuring said spectra allows the determination of the elemental composition of the original sample.

Sample introduction systems may be employed to introduce the liquid samples into the ICP mass spectroscopy instrumentation (e.g., an inductively coupled plasma mass spectrometer (ICP/ICPMS), an inductively coupled plasma atomic emission spectrometer (ICP-AES), or the like) for analysis. For example, a sample introduction system may withdraw an aliquot of a liquid sample from a container and thereafter transport the aliquot to a nebulizer that converts the aliquot into a polydisperse aerosol suitable for ionization in plasma by the ICP mass spectrometry instrumentation. The aerosol is then sorted in a spray chamber to remove the larger aerosol particles. Upon leaving the spray chamber, the aerosol is introduced to the ICPMS or ICPAES instruments for analysis. Often, the sample introduction is automated to allow a large number of samples to be introduced into the ICP mass spectroscopy instrumentation in an efficient manner.

### SUMMARY

Systems and methods for analyzing fluid samples containing nanoparticles for the determination of nanoparticle count and nanoparticle elemental composition are described. In an aspect, a system embodiment includes, but is not limited to, a remote sampling system configured to receive a fluid sample containing nanoparticles, the remote sampling system including a particle counter configured to determine a number of nanoparticles present in the fluid sample via light scattering detection and provide a first data output associated with the number of nanoparticles present in the fluid sample; a sample analysis system fluidically coupled with the remote sampling system, the sample analysis system configured to receive the fluid sample from the remote sampling system, the sample analysis system including a mass spectrometer configured to determine an elemental composition of the nanoparticles present in the fluid sample and provide a second data output associated with the elemental composition of the nanoparticles present in the fluid sample; and a system controller communicatively coupled with each of the remote sampling system and the sample analysis system to access the first data output and the second data output, the system controller including a computer processor configured to modify a combination of the first data output and the second data output to provide a distribution of the nanoparticles in the fluid sample by specific element type.

In an aspect, a method embodiment includes, but is not limited to, receiving, via a remote sampling system, a fluid sample containing nanoparticles; transferring the fluid sample to a particle counter configured to determine a number of nanoparticles present in the fluid sample via light scattering detection; providing, via the particle counter, a first data output associated with the number of nanoparticles present in the fluid sample; transferring the fluid sample to a sample analysis system fluidically coupled with the remote sampling system, the sample analysis system including a mass spectrometer configured to determine an elemental composition of the nanoparticles present in the fluid sample; providing, via the mass spectrometer, a second data output associated with the elemental composition of the nanoparticles present in the fluid sample; accessing, via a system controller communicatively coupled with each of the remote sampling system and the sample analysis system, the first data output and the second data output; and modifying, via a computer processor, a combination of the first data output and the second data output to provide a distribution of the nanoparticles in the fluid sample by specific element type.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The Detailed Description is described with reference to the accompanying figures.

FIG. 1 is a schematic illustration of a system for analysis of fluid samples containing nanoparticles to determine number of nanoparticles and the corresponding elemental composition of the nanoparticles in accordance with an example implementation of the present disclosure.

FIG. 2 is a flow chart of a method for analyzing fluid samples containing nanoparticles for the determination of nanoparticle count and nanoparticle elemental composition in accordance with an example implementation of the present disclosure.

FIG. 3A is an example dataset of a sample analyzed by the system of FIG. 1, shown with the number of nanoparticles of silicon detected within a plurality of size ranges over time in accordance with an example implementation of the present disclosure.

FIG. 3B is an example dataset of a sample analyzed by the system of FIG. 1, shown with the number of nanoparticles of multiple analytes detected over time in accordance with an example implementation of the present disclosure.

FIG. 4 is a schematic illustration of the remote sampling system of the system of FIG. 1, shown with a plurality of internal standards with differing nanoparticle sizes in accordance with an example implementation of the present disclosure.

FIG. 5 is a schematic illustration of the remote sampling system of the system of FIG. 1 including a degasser prior to introduction of the fluid sample to the particle counter in accordance with an example implementation of the present disclosure.

### DETAILED DESCRIPTION

### Overview

Nanoparticle research has grown to encompass applications from the medical industry to the environmental industry. Such applications can focus on capabilities to detect nanoparticles (e.g., particles of less than 1000 nm in diameter) and to calculate the sizes of nanoparticles present in a sample. However, determining what is a nanoparticle and what is not a nanoparticle when analyzing spectrometry data poses many challenges. For instance, spectrometry data, such as ICPMS data, includes information associated with ionized samples and background interference, such as resulting from plasma gases introduced to the ICP torch, that can overlap with data associated with small nanoparticles. For example, as the size of the nanoparticle decreases, the spectrometry data of the nanoparticle begins to converge with data associated with ionic species produced by the ICP torch. The nanoparticle signal convergence and the difficulty of isolating the nanoparticle data can further compound with dilute concentrations of acid sample matrices. However, if data analysis removes too much data as background interference risks removal of data corresponding to nanoparticles present in the sample, particularly for small nanoparticles (e.g., nanoparticles less than 30 nm). The overlap between nanoparticle signal and background interference signal and the associated challenges with removing background interferences, while avoiding nanoparticle data removal, lead to continued problems in providing reliable data associated with nanoparticles, including, but not limited to, identification of nanoparticles, determination of the number of nanoparticles and their associated size distributions, identification of the composition of nanoparticles, and the like.

Another technique to count nanoparticles present in fluid samples involves measurement of light scattering, where a light source (e.g., a laser) is directed into a fluid sample containing nanoparticles. The nanoparticles scatter the light based on an index of refraction difference between the fluid sample matrix and the particle, where the scattering characteristics generally depend on the particle size, particle shape, and index of refraction. The scattered light is directed to a photodetector to generate an electric signal, which can be compared against reference electric signals generated from nanoparticles of known size and/or shape included in a calibration standard. However, while the light scattering techniques are able to differentiate between sizes of nanoparticles, the techniques are unable to identify or differentiate between the composition of one nanoparticle and another nanoparticle. For instance, a 20 nm organic nanoparticle generally provides the same light scattering as a 20 nm metal nanoparticle. Similarly, the light scattering techniques are unable to distinguish between two metallic nanoparticles having differing compositions. For instance, a particle counter utilizing light scattering techniques is unable to distinguish a 30 nm iron (Fe) particle from a 30 nm silicon (Si) particle.

Additionally, calibration of light scattering techniques can rely on third order polynomial distribution relationships between the number of particles and the particle size, where even small errors in sizing a nanoparticle translate to large errors in the number of nanoparticles counted. For example, a 2% error in calibration of sizing of the nanoparticles can translate to a 6% error on the number of nanoparticles counted by light scattering techniques, whereas a 5% error in calibration of sizing of the nanoparticles can translate to a 17% error on the number of nanoparticles counted by light scattering techniques. Techniques that rely on a single calibration standard can unknowingly introduce significant error into the analysis of nanoparticles with even small margins of error introduced during analysis of the single calibration standard.

Further issues associated with light scattering techniques to analyze nanoparticles include a reduced ability to analyze concentrated semiconductor fabrication liquid media and inability to differentiate between nanoparticles and bubbles in a sample. For instance, conventional techniques to analyze nanoparticles have reduced ability to identify nanoparticles in concentrated chemicals such as concentrated chemicals used in semiconductor fabrication processes due in part to the high refractive index present in such chemical media. Additionally, conventional techniques to analyze nanoparticles cannot suitably differentiate between bubbles or other voids that may be present in a liquid sample, where such bubbles may be introduced through transfer of the fluid through a system (e.g., flowing through fluid lines, valves, headers, etc.), atmospheric pressure changes, or the like, particularly for low surface tension fluids such as ammonia, ammonium hydroxide, isopropyl alcohol, organic samples, surfactants, and the like.

Accordingly, in one aspect, the present disclosure is directed to systems and methods for analyzing fluid samples containing nanoparticles for the determination of nanoparticle count and nanoparticle elemental composition. The fluid samples can be analyzed by each of a light scattering particle counter and a mass spectrometer, such as an inductively coupled plasma mass spectrometer (ICP/ICPMS), an inductively coupled plasma atomic emission spectrometer (ICP-AES), or the like. For instance, the particle counter can measure a total number of nanoparticles and a distribution of sizes of the nanoparticles, whereas the mass spectrometer can analyze the elemental composition of the nanoparticles, as well provide a secondary analysis of nanoparticle count, where the combined output of the particle counter and the mass spectrometer can be used to determine the composition of the nanoparticles by element. For example, the combined output of the particle counter and the mass spectrometer can determine a total metal particle percentage composition by element.

In aspects, the systems facilitate calibration of the light scattering particle counter by providing a plurality of calibration curves utilizing multiple particle size standards. For example, a remote sampling system can include pump and valve systems fluidically coupled a plurality of internal standard sources, such as internal nanoparticle standards having different nanoparticle sizes, to automatically generate multiple individual calibration curve profiles. Fluid samples introduced to the particle counter can be compared against the calibration curves of the plurality of internal standards to accurately determine particle size and particle count of nanoparticles present in the fluid sample.

In aspects, the systems can automatically adjust the refractive index of the chemical matrix of the fluid sample to enhance detection of nanoparticles present in the chemical matrix. For example, a remote sampling system can include pump and valve systems fluidically coupled with a diluent source to automatically dilute the chemical matrix of the fluid sample to more closely align the refractive index of the chemical matrix with a different solvent or chemical (e.g., water) prior to introducing the diluted fluid sample to the light scattering particle counter.

In aspects, the system can automatically remove bubbles or otherwise degas the fluid sample prior to introducing the fluid sample to the light scattering particle counter to prevent false positive identification of nanoparticles due to the presence of bubbles in the fluid sample. For example, a remote sampling system can include pump and valve systems fluidically coupled with a degas chamber to remove gases (e.g., entrained bubbles) prior to introducing the degassed fluid sample to the light scattering particle counter.

### Example Implementations

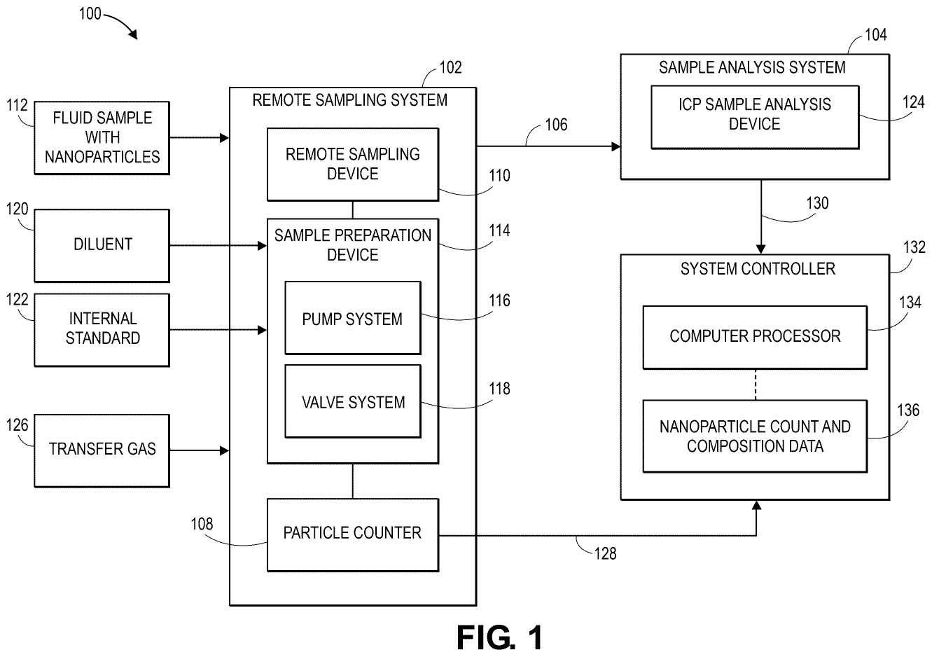

Referring generally to FIGS. 1 through 5, a system 100 for analysis of nanoparticles contained in fluid samples is shown in accordance with example implementations of the present disclosure. The system 100 generally includes a remote sampling system 102 fluidically coupled with a sample analysis system 104 via a fluid transfer line 106, where the remote sampling system 102 includes a particle counter 108. For instance, the remote sampling system 102 is shown including a remote sampling device 110 configured to receive a fluid sample from a fluid sample source 112. The remote sampling device 110 can include, but is not limited to, an autosampler system including a sample probe for introduction into the fluid sample source 112 (e.g., a fluid container adjacent to or supported by the autosampler), a fluid inlet coupled with a chemical storage tank or chemical transfer system (e.g., a chemical pipe or conduit), a fluid inlet coupled with a chemical transport vehicle at a chemical receiving dock, or the like, or combinations thereof.

The remote sampling system 102 is also shown including a sample preparation device 114 configured to prepare the fluid sample from the fluid sample source 112 for analysis by one or both of the particle counter 108 and the sample analysis system 104. For instance, the sample preparation device 114 can include a pump system 116 and a valve system 118 fluidically coupled with fluid sources to mix with the fluid sample drawn by the remote sampling device 110 prior to transfer to the particle counter 108 and/or to the sample analysis system 104. For example, the sample preparation device 114 can be fluidically coupled with the remote sampling device 110 to receive the fluid sample (e.g., via the pump system 116 and the valve system 118) and to introduce to the fluid sample one or more of a diluent (e.g., water, such as ultrapure water (UPW)) received from a diluent source 120 and an internal standard chemical from one or more internal standard chemical sources 122. In implementations, the sample preparation device 114 can introduce the diluent to the fluid sample to adjust a refractive index of the fluid sample prior to analysis by the particle counter 108, as described further herein.

In implementations, the sample preparation device 114 can introduce the internal standard chemical, with or without prior dilution, to the particle counter 108 for calibration curve generation for the analysis of the fluid sample via the particle counter 108 and/or the sample analysis system 104. Alternatively or additionally, the sample preparation device 114 can introduce the internal standard chemical to the fluid sample received from the remote sampling device, with or without dilution, prior to transfer of the fluid sample to the the particle counter 108 and/or the sample analysis system 104 for analysis.

The sample analysis system 104 is shown including a sample analysis device 124 to analyze the elemental composition of the fluid sample received from the remote sampling system 102 via the transfer line 106, such as by providing trace elemental concentrations, isotope ratios, or the like. The sample analysis device 124 can include, but is not limited to, a mass spectrometer, such as an inductively coupled plasma mass spectrometer (ICP/ICPMS), an inductively coupled plasma atomic emission spectrometer (ICP-AES), or the like. In implementations, the sample analysis device 124 includes a plurality of analysis devices, such as ICPMS (e.g., for trace metal determinations), inductively coupled plasma optical emission spectrometer ICPOES (e.g., for trace metal determinations), ion chromatograph (e.g., for anion and cation determinations), liquid chromatograph (LC) (e.g., for organic contaminants determinations), Fourier transform infrared spectroscope (FTIR) infrared (e.g., for chemical composition and structural information determinations), particle counter (e.g., for detection of undissolved particles, such as particle counter 108 or a different or additional particle counter), moisture analyzer (e.g., for detection of water in samples), gas chromatograph (GC) (e.g., for detection of volatile components), or the like.

In implementations, the remote sample system 102 includes a transfer gas supply 126 configured to transfer the fluid sample through the fluid transfer line 106 to the sample analysis system 104 through gas pressure sample transfer. For instance, the fluid transfer line 106 can fluidically couple the remote sampling system 102 with the sample analysis system 104 to account for a variety of spacing configuration. For example, the fluid transfer line 106 can be sufficiently long to provide up to hundreds of meters of separation between the remote sample system 102 and the sample analysis system 104, as described, for example, in U.S. Pat. No. 10,585,108, which is incorporated by reference in its entirety. Gas pressure sample transfer can facilitate transfer of a portion of sample from the remote sample system 102 to the sample analysis system 104 without filling the entire fluid transfer line 106 with sample, which can reduce the amount of sample drawn by the remote sampling system 102 to reduce sample waste. Alternatively or additionally, the remote sample system 102 can include a pump to fill the fluid transfer line 106 with sample for transfer to the sample analysis system 104.

The system 100 can analyze the fluid sample (e.g., optionally modified by dilution, internal standard addition, additional chemical mixing, etc.) through both of the particle counter 108 and the sample analysis device 124 to provide a first data output 128 from the particle counter 108 and a second data output 130, each accessible by a system controller 132. For instance, the particle counter 108 can measure a total number of nanoparticles and a distribution of sizes of the nanoparticles in the fluid sample to provide the first data output 128, whereas the sample analysis device 120 can analyze the elemental composition of the nanoparticles in the fluid sample (as well provide a secondary analysis of nanoparticle count) to provide the second data output 130. The system controller 132 generally includes a computer processor 134 to access (e.g., via computer memory storage, via server data, via communication protocol, etc.) each of the first data output 128 and the second data output 130 and to modify the respective data outputs to provide a combined data output 136 providing the distribution of the nanoparticles by specific element type. For example, the combined data output 136 of the particle counter 108 and the sample analysis device 120 can provide a total metal particle percentage composition by element of the nanoparticles present in the fluid sample.

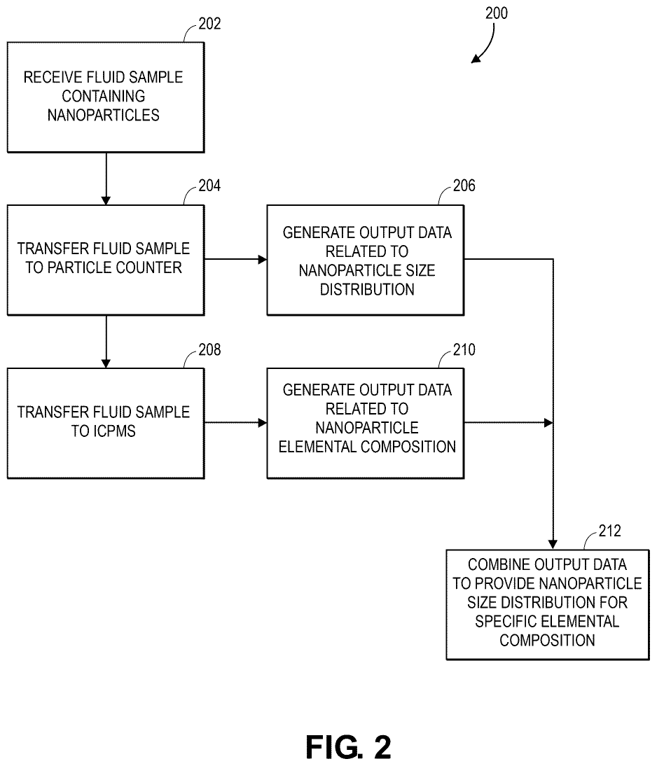

Referring to FIG. 2, a method 200 for analyzing fluid samples containing nanoparticles for the determination of nanoparticle count and nanoparticle elemental composition is shown in accordance with an example implementation of the present disclosure. The method 200 includes receiving a fluid sample containing nanoparticles in block 202. For example, the remote sampling system 102 can acquire a fluid sample containing nanoparticles via the remote sampling device 110 through one or more of an autosampler system including a sample probe for introduction into the fluid sample source 112, a fluid inlet coupled with a chemical storage tank or chemical transfer system, a fluid inlet coupled with a chemical transport vehicle at a chemical receiving dock, or the like. The method 200 also includes transferring the fluid sample to a particle counter in block 204. For example, the remote sample system 102 can transfer the fluid sample received by the remote sampling device 110 to the particle counter 108, such as via the pump system 118, vacuum source, gas pressure transfer, or any other suitable transfer mechanism.

The method 200 also includes generating output data related to nanoparticle size distribution of the fluid sample in block 206. For instance, the particle counter 108 can utilize light scattering detection to generate nanoparticle sense data over time, such as to quantify the number of nanoparticles detected, the size distribution of nanoparticles, the number of nanoparticles within a given size range (e.g., number of nanoparticles under 50 nm, number of nanoparticles from 50 nm to 100 nm, number of nanoparticles from 100 nm to 150 nm, number of nanoparticles from 150 nm to 200 nm etc.), or the like, for a given time period or on a continuous basis. For example, the particle counter 108 can generate the first data output 130 for access by the system controller 132.

The method 200 also includes transferring the fluid sample to an ICPMS analysis system in block 208. For instance, the fluid sample received in block 202 can be transferred from the remote sampling system 102 to the sample analysis device 104 via the fluid transfer line 106 for analysis of the elemental composition of the nanoparticles present in the fluid sample. In implementations, the fluid sample is transferred from the particle counter 108 to the sample analysis device 124 for serial sample analysis (e.g., with an initial analysis of the fluid sample by the particle counter 108 with transfer to, and subsequent analysis by, the sample analysis device 124 positioned downstream from the particle counter 108). Alternatively or additionally, separate portions of the sample received in block 202 can be transferred to the particle counter 108 and the sample analysis device 124, such as in a simultaneous manner. In implementations, such as those with serial sample analysis of the same fluid sample, the transfer rate from the remote sampling system 102 to the sample analysis system 104 is a predetermined rate or a measured rate, such that data generated by the particle counter 108 can be correlated to data of the same sample analyzed by the sample analysis device 124 (e.g., via a time offset from transfer from the particle counter 108 to the sample analysis device 124). In implementations, such as those with simultaneous sample analysis of separate portions of the sample, the sample can be treated as a substantially homogenous sample such that the data generated by each of the particle counter 108 and the sample analysis device 124 can be directly correlated with each other.

The method 200 also includes generating output data related to nanoparticle elemental composition in block 210. For instance, the sample analysis device 124 can include the ICPMS to analysis the fluid sample and output data associated with nanoparticle elemental composition, such as the frequency of occurrence of detection of elements and isotopes thereof. The frequency data can be correlated to an analyte concentration present in the fluid sample through coordination with data of calibration curves of known sample concentrations of one or more analytes of interest. For example, the sample analysis device 124 can generate the second data output 132 for access by the system controller 132.

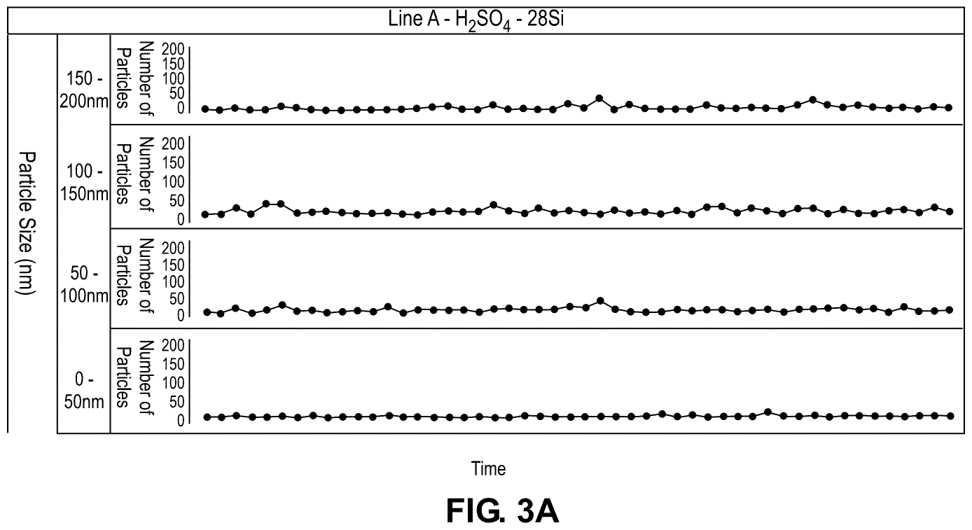

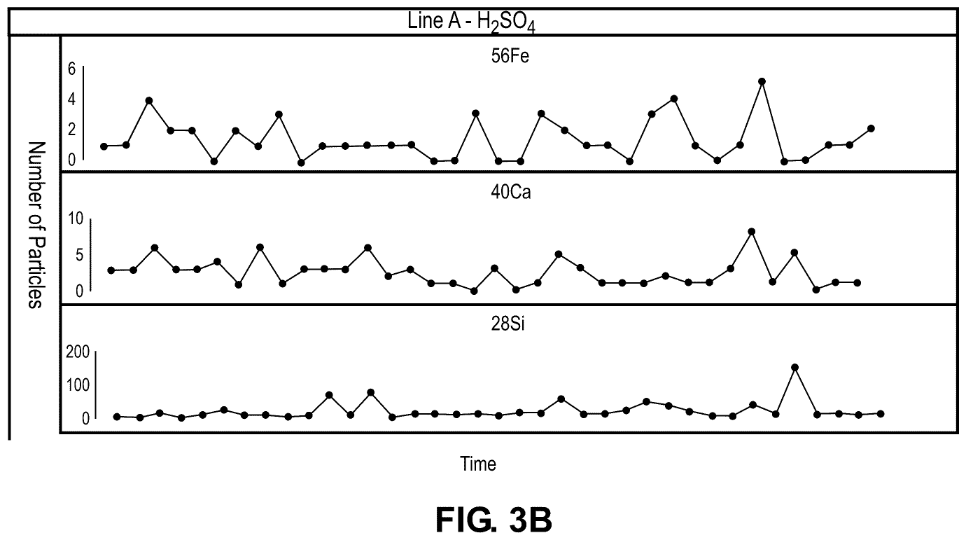

The method 200 also includes combining the output data from block 206 and block 210 to provide a combined output data reflecting nanoparticle size distribution for specific elemental composition of the nanoparticles present in the fluid sample in block 212. For instance, the system controller 132 can access the first data output 128 and the second data output 130 for modification via the computer processor 134 to determine the combined data output 136, providing the distribution of the nanoparticles by specific element type. For example, referring to FIG. 3A, an example combined data output from the computer processor 134 is shown, where the number of nanoparticles of silicon detected within a given size range is provided. The example combined data output is shown over time with the number of detected silicon nanoparticles under 50 nm, the number of detected silicon nanoparticles from 50 nm to 100 nm, the number of detected silicon nanoparticles from 100 nm to 150 nm, and the number of detected silicon nanoparticles from 150 nm to 200 nm for a given sample matrix (i.e., sulfuric acid). Without combination of the ICPMS data, the data from the particle counter 108 would merely output the number of detected nanoparticles over time, without any accurate reference to a particular species of analyte. For instance, only the total detected nanoparticles over time could be provided, with no data associated with individual species or individual groupings of species (e.g., total metals)).

Referring to FIG. 3B, another example of the combined data output from the computer processor 134 is shown, where the number of particles over time for multiple individual species are shown separately. For instance, data associated with the number of particles over time of iron is shown separately from data of each of the number of particles over time of calcium and the number of particles over time of silicon for a given sample matrix (i.e., sulfuric acid). While the data series are shown separately, the data can be combined or overlaid according to any suitable data presentation, such as in table form, overlaid with a common scale, etc.

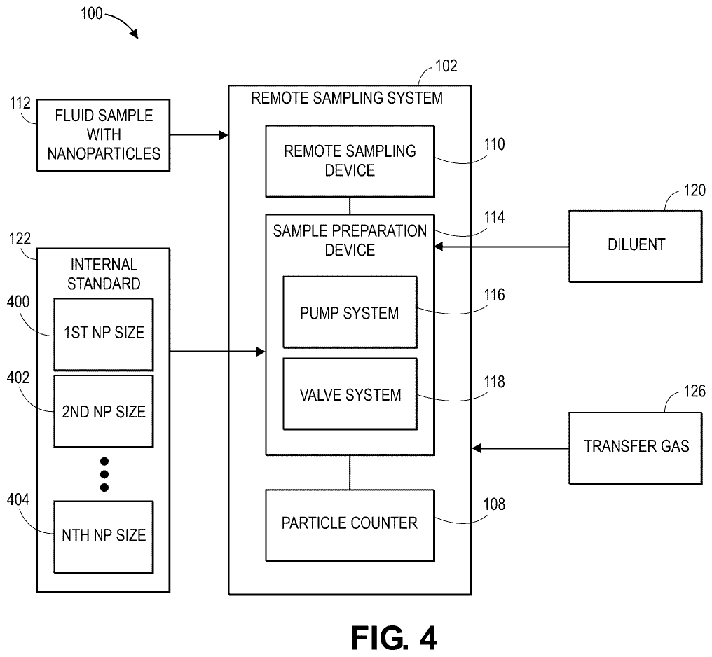

The system 100 can facilitate a variety of calibration schemes for sample fluids transferred to the particle counter 108 or the sample analysis device 120. For instance, the system 100 can facilitate calibration of the particle counter 108 by providing a plurality of calibration curves utilizing multiple particle size standards with differing average nanoparticle size. For example, referring to FIG. 4, the system 100 is shown with the internal standard 122 including any number of particle size standards, where an internal standard with a first nanoparticle size 400 and an internal standard with a second nanoparticle size 402 are shown, with up to N separate or combined particle sizes present in the internal standard 122 (e.g., “Nth” particle size standard 404). The system 100 can analyze the internal standard with the first nanoparticle size 400 to generate a first calibration curve for the first nanoparticle size, can analyze the internal standard with the second nanoparticle size 402 to generate a second calibration curve for the second nanoparticle size, and can analyze any number of additional internal standards to generate the desired number of calibration curves to compare detection signals from the fluid sample 112 against to determine an appropriate detected nanoparticle size or size range. Since calibration of light scattering techniques used by the particle counter 108 can rely on third order polynomial distribution relationships between the number of particles and the particle size, even small errors in sizing a nanoparticle can translate to large errors in the number of nanoparticles counted. For example, a 2% error in calibration of sizing of the nanoparticles can translate to a 6% error on the number of nanoparticles counted by light scattering techniques, whereas a 5% error in calibration of sizing of the nanoparticles can translate to a 17% error on the number of nanoparticles counted by light scattering techniques. By utilizing multiple calibration curves, the system 100 can reduce the likelihood of a calibration error in the analysis of the fluid sample 112, thereby providing more reliable data output (e.g., at block 206 and at block 212 of the method 200 shown in FIG. 2).

In implementations, the sample preparation device 114 can prepare individual calibration curves for each of the internal standards received from the internal standard source 118 to automatically dilute each of the internal standards according to individual calibration curve profiles with diluent from the diluent source 116, such as to provide individually calibrated analytes for calibration curves of differing analyte concentrations for the sample analysis system 104.

The system 100 can facilitate automatic adjustment of the refractive index of the chemical matrix of the fluid sample prior to introduction of the fluid sample to the particle counter 108 to enhance detection of nanoparticles present in the chemical matrix. For example, the sample preparation device 114 can introduce diluent from the diluent source 116 to automatically dilute the chemical matrix of the fluid sample to more closely align the refractive index of the chemical matrix with water (e.g., ultrapure water “UPW”) prior to introducing the diluted fluid sample to the light scattering particle counter 108. In implementations, the system 100 automatically introduces an amount of diluent based on an identity of the chemical matrix in the fluid sample, where the identity can be associated with the fluid sample according to any appropriate manner (e.g., via barcode scanner, via manual input into the system 100 via a user interface, etc.). Example refractive indexes for chemicals used in semiconductor fabrication processes are shown with respect to Table 1.

TABLE 1

| Chemical | Refractive Index |
|---|---|
| Semiconductor thinner | 1.426 |
| Propylene glycol methyl ether acetate | 1.42-1.45 |
| (PGMEA) | |
| Propylene glycol methyl ether (PGME) | 1.403 |
| Tetramethylammonium hydroxide (TMAH) | 1.382 |
| Isopropyl alcohol (IPA) | 1.3772 |
| 30% Hydrogen peroxide (H₂O₂) | 1.335 |
| 25% Ammonium hydroxide (NH₄OH) | 1.330 |
| Ultrapure water (UPW) | 1.330 |
| 98% Sulfuric acid (H₂SO₄) | 1.418 |
| 50% H₂SO₄ | 1.400 |
| 25% H₂SO₄ | 1.380 |
| 10% H₂SO₄ | 1.346 |
| 5% H₂SO₄ | 1.335 |

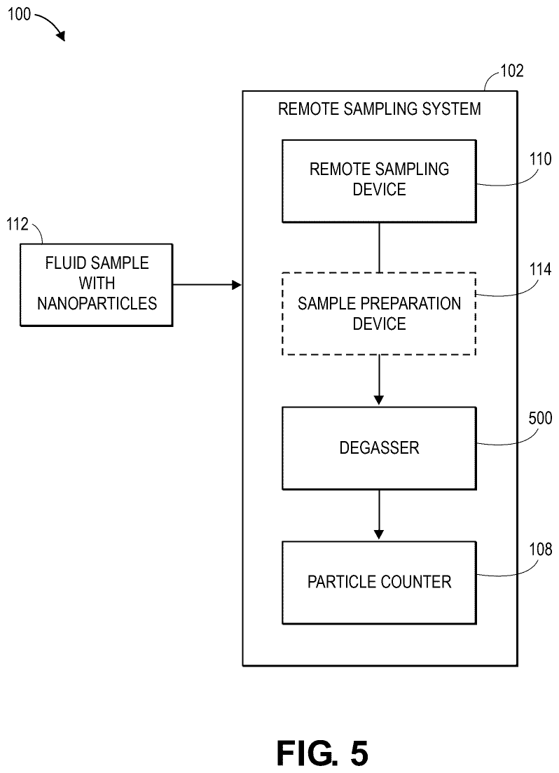

The system 100 can include a degas chamber to facilitate removal of gases entrained in the fluid sample, such as for high viscosity sample matrices that trap gases and for solvents with high vapor pressures. For example, referring to FIG. 5, the system 100 is shown with the remote sampling system 102 including a degasser 500 fluidically coupled between the remote sampling device 110 (or the sample preparation device 114 if included in the remote sampling system 110) and the particle counter 108 for gas/bubble removal prior to analysis of the nanoparticles by the particle counter 108. In implementations, the degasser 500 includes a degassing chamber to which the fluid sample is introduced, where the degassing chamber has a lateral cell extending therefrom. A displacement gas can be introduced into a top portion of the degassing cell in a first valve configuration to permit the displacement gas to push a portion of the sample above the lateral extension out from the degassing chamber, where a second valve configuration fluidically couples a vacuum source with the degassing chamber to remove gases from the fluid sample. For example, the degasser 500 can include a degassing system described in U.S. Pat. No. 11,315,776, which is incorporated herein by reference in its entirety. Once the gas removal process has been completed in the degasser 500, the degassed sample can be transferred to the particle counter 108 for analysis without the presence of bubbles in the fluid sample that would otherwise be interpreted by the particle counter 108 as particles.

Electromechanical devices (e.g., electrical motors, servos, actuators, or the like) may be coupled with or embedded within the components of the system 100 to facilitate automated operation via control logic embedded within or externally driving the system 100. The electromechanical devices can be configured to cause movement of devices and fluids according to various procedures, such as the procedures described herein. The system 100 may include or be controlled by a computing system having a processor or other controller configured to execute computer readable program instructions (i.e., the control logic) from a non-transitory carrier medium (e.g., storage medium such as a flash drive, hard disk drive, solid-state disk drive, SD card, optical disk, or the like). The computing system can be connected to various components of the system 100, either by direct connection, or through one or more network connections (e.g., local area networking (LAN), wireless area networking (WAN or WLAN), one or more hub connections (e.g., USB hubs), and so forth). For example, the computing system can be communicatively coupled to a system controller, ICP torch, carriage motors, fluid handling systems (e.g., valves, pumps, etc.), other components described herein, components directing control thereof, or combinations thereof. The program instructions, when executed by the processor or other controller, can cause the computing system to control the system 100 according to one or more modes of operation, as described herein.

It should be recognized that the various functions, control operations, processing blocks, or steps described throughout the present disclosure may be carried out by any combination of hardware, software, or firmware. In some embodiments, various steps or functions are carried out by one or more of the following: electronic circuitry, logic gates, multiplexers, a programmable logic device, an application-specific integrated circuit (ASIC), a controller/microcontroller, or a computing system. A computing system may include, but is not limited to, a personal computing system, a mobile computing device, mainframe computing system, workstation, image computer, parallel processor, or any other device known in the art. In general, the term “computing system” is broadly defined to encompass any device having one or more processors or other controllers, which execute instructions from a carrier medium.

Program instructions implementing functions, control operations, processing blocks, or steps, such as those manifested by embodiments described herein, may be transmitted over or stored on carrier medium. The carrier medium may be a transmission medium, such as, but not limited to, a wire, cable, or wireless transmission link. The carrier medium may also include a non-transitory signal bearing medium or storage medium such as, but not limited to, a read-only memory, a random access memory, a magnetic or optical disk, a solid-state or flash memory device, or a magnetic tape.

### CONCLUSION

It will be appreciated that features described herein with respect to embodiments or implementations can be combined with any other feature or features described with respect to the same or alternative embodiments, unless context otherwise dictates, without departing from the scope of the present disclosure.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A system for analysis of nanoparticle content of a fluid sample, comprising:
a remote sampling system configured to receive a fluid sample containing nanoparticles, the remote sampling system including a particle counter configured to determine a number of nanoparticles present in the fluid sample via light scattering detection and provide a first data output associated with the number of nanoparticles present in the fluid sample;
a sample analysis system fluidically coupled with the remote sampling system, the sample analysis system configured to receive the fluid sample from the remote sampling system, the sample analysis system including a mass spectrometer configured to determine an elemental composition of the nanoparticles present in the fluid sample and provide a second data output associated with the elemental composition of the nanoparticles present in the fluid sample; and
a system controller communicatively coupled with each of the remote sampling system and the sample analysis system to access the first data output and the second data output, the system controller including a computer processor configured to modify a combination of the first data output and the second data output to provide a distribution of the nanoparticles in the fluid sample by specific element type.

2. The system of claim 1, wherein the remote sampling system is configured to receive a plurality of internal standards to generate a plurality of calibration curves for calibration of the particle counter.

3. The system of claim 2, wherein the plurality of internal standards includes internal standards having different average nanoparticles sizes.

4. The system of claim 1, wherein the remote sampling system is configured to dilute the fluid sample to decrease a refractive index of the fluid sample prior to analysis by the particle counter.

5. The system of claim 1, further comprising a degasser fluidically coupled to the particle counter, the degasser configured to remove gas from the fluid sample prior to introduction to the particle counter.

6. The system of claim 1, wherein the distribution of the nanoparticles in the fluid sample by specific element type provided by the computer processor includes a number of nanoparticles of the specific element type detected within a given nanoparticle size range.

7. The system of claim 1, wherein the distribution of the nanoparticles in the fluid sample by specific element type provided by the computer processor includes a number of nanoparticles of the specific element type detected within multiple nanoparticle size ranges.

8. The system of claim 1, wherein the distribution of the nanoparticles in the fluid sample by specific element type provided by the computer processor includes a number of nanoparticles of the specific element type over time.

9. The system of claim 1, wherein the distribution of the nanoparticles in the fluid sample by specific element type provided by the computer processor includes a number of nanoparticles of multiple specific element types over time identified by the mass spectrometer.

10. The system of claim 1, wherein the particle counter and the mass spectrometer are arranged in a serial arrangement with the mass spectrometer positioned downstream from the particle counter and configured to receive the fluid sample subsequent to analysis of the fluid sample by the particle counter.

11. The system of claim 1, wherein the particle counter and the mass spectrometer are configured to receive separate portions of the fluid sample simultaneously.

12. A method for analysis of nanoparticle content of a fluid sample, comprising:
receiving, via a remote sampling system, a fluid sample containing nanoparticles;
transferring the fluid sample to a particle counter configured to determine a number of nanoparticles present in the fluid sample via light scattering detection;
providing, via the particle counter, a first data output associated with the number of nanoparticles present in the fluid sample;
transferring the fluid sample to a sample analysis system fluidically coupled with the remote sampling system, the sample analysis system including a mass spectrometer configured to determine an elemental composition of the nanoparticles present in the fluid sample;
providing, via the mass spectrometer, a second data output associated with the elemental composition of the nanoparticles present in the fluid sample;
accessing, via a system controller communicatively coupled with each of the remote sampling system and the sample analysis system, the first data output and the second data output; and
modifying, via a computer processor, a combination of the first data output and the second data output to provide a distribution of the nanoparticles in the fluid sample by specific element type.

13. The method of claim 12, further comprising:
receiving a plurality of internal standards to generate a plurality of calibration curves for calibration of the particle counter.

14. The method of claim 13, wherein the plurality of internal standards includes internal standards having different average nanoparticles sizes.

15. The method of claim 12, further comprising:
diluting the fluid sample, via the remote sampling system, to decrease a refractive index of the fluid sample prior to analysis by the particle counter.

16. The method of claim 12, further comprising:
removing gas from the fluid sample, via a degasser fluidically coupled to the particle counter, prior to introduction of the fluid sample to the particle counter.

17. The method of claim 12, wherein the distribution of the nanoparticles in the fluid sample by specific element type provided by the computer processor includes a number of nanoparticles of the specific element type detected within at least one given nanoparticle size range.

18. The method of claim 12, wherein the distribution of the nanoparticles in the fluid sample by specific element type provided by the computer processor includes a number of nanoparticles of multiple specific element types over time identified by the mass spectrometer.

19. The method of claim 12, wherein the particle counter and the mass spectrometer are arranged in a serial arrangement with the mass spectrometer positioned downstream from the particle counter and configured to receive the fluid sample subsequent to analysis of the fluid sample by the particle counter.

20. The method of claim 12, wherein the particle counter and the mass spectrometer are configured to receive separate portions of the fluid sample simultaneously.
